(19) United States
(12) Patent Application Publication
(10) Pub. No.: US 2013/0192985 A1
(43) Pub. Date: Aug. 1, 2013

(54) ELECTRODE CATALYST

(71) Applicants: Takeshi Hattori, Abiko-Shi (JP); Yutaka Ito, Tsukuba-shi (JP); Hajime Maki, Tsukuba-shi (JP); Hideto Imai, Tokyo (JP); Kenichiro Ota, Koganei-shi (JP)

(72) Inventors: Takeshi Hattori, Abiko-Shi (JP); Yutaka Ito, Tsukuba-shi (JP); Hajime Maki, Tsukuba-shi (JP); Hideto Imai, Tokyo (JP); Kenichiro Ota, Koganei-shi (JP)

(73) Assignees: NEC CORPORATION, Minato-ku, Tokyo (JP); SUMITOMO CHEMICAL COMPANY, LIMITED, Chuo-ku, Tokyo (JP)

(21) Appl. No.: 13/808,142

(22) PCT Filed: Jul. 6, 2011
(86) PCT No.: PCT/JP2011/065456

§ 371 Date: Apr. 15, 2013

(30) Foreign Application Priority Data
Jul. 6, 2010 (JP) 2010-154210

(51) Int. Cl. C25B 11/04; H01M 4/86

(52) U.S. Cl. CPC C25B 11/0405; C25B 11/0415; C25B 11/0447; H01M 4/8657
USPC 204/290.12

(57) ABSTRACT

An electrode catalyst, including: a metal compound which contains an oxygen atom and at least one metal element selected from a group consisting of Group 4 elements and Group 5 elements in the long-form periodic table, and a carbonaceous material which covers at least part of the metal compound; wherein an oxygen deficiency index, which is represented as an inverse number of a peak value of a first nearest neighbor element in a radial distribution function obtained by Fourier-transforming an EXAFS oscillation in EXAFS measurement of the metal element, is 0.125 to 0.170; and a crystallinity index, which is represented as a peak value of a second nearest neighbor element in the radial distribution function, is 4.5 to 8.0.

### TECHNICAL FIELD

The present invention relates to an electrode catalyst. Priority is claimed on Japanese Patent Application No. 2010-154210, filed Jul. 6 2010, the content of which is incorporated herein by reference.

### BACKGROUND ART

An electrode catalyst is a solid catalyst that is supported on an electrode, particularly on the surface region of an electrode, and is used, for example, not only in electrolysis of water and electrolysis of organic matter, but also in the electrochemical systems of fuel cells and the like. As electrode catalysts used in an acidic electrolyte, the noble metals—particularly platinum—are widely used due to their stability in an acidic electrolyte even at high potential.

However, it has been pointed out that platinum is problematic in that it is expensive, and its supply may become depleted in the future due to limited deposits. Consequently, in recent years, development has proceeded with respect to electrode catalysts using, as a formative material, a material that has physical properties substitutable with platinum, and that is relatively inexpensive and in abundant resource supply.

For example, tungsten carbide is known as an electrode catalyst that is relatively inexpensive and capable of being used in an acidic electrolyte (see Non-Patent Document 1), and an electrode catalyst composed of zirconium oxide is known as an electrode catalyst that is scarcely soluble when used at high potential (see Non-Patent Document 2).

### PRIOR ART REFERENCES

### Non-Patent Documents

Non-Patent Document 1: Hiroshi Yoneyama, et al.: “Electrochemistry,” Vol. 41, page 719 (1973).

Non-Patent Document 2: Yan Liu, et al.: “Electrochemical and Solid-State Letters,” 8(8), 2005, A400-402.

### SUMMARY OF THE INVENTION

### Problems that the Invention is to Solve

However, the aforementioned tungsten carbide is problematic in that it dissolves at high potential, and the electrode catalyst composed of zirconium oxide yields a low current value when used. These electrode catalysts are unable to fully satisfy the requirements of an electrode catalyst.

The object of the present invention is to provide an electrode catalyst that is substitutable with the conventionally used electrode catalyst that has platinum as its formative material. In particular, its object is to provide a highly active electrode catalyst which can be used at high potential in an acidic electrolyte, and which can be obtained using a material that is relatively inexpensive and in relatively abundant resource supply.

### Means for Solving the Problems

The present invention offers the following.

[1] An electrode catalyst, including: a metal compound which contains an oxygen atom and at least one metal element selected from a group consisting of Group 4 elements and Group 5 elements in the long-form periodic table, and a carbonaceous material which covers at least part of the metal compound; wherein an oxygen deficiency index, which is represented as an inverse number of a peak value of a first nearest neighbor element in a radial distribution function obtained by Fourier-transforming an EXAFS oscillation in EXAFS measurement of the aforementioned metal element, is 0.125 to 0.170; and a crystallinity index, which is represented as a peak value of a second nearest neighbor element in the aforementioned radial distribution function, is 4.5 to 8.0.

[2] The electrode catalyst according to [1] in which a BET specific surface area is 15 m²/g to 500 m²/g, and carbon coverage obtained by the following formula (1) is 0.05 g/m² to 0.5 g/m².

(Formula 1)

Carbon coverage (g/m²)=carbon content (mass %)/BET specific surface area (m²/g) (1)

The electrode catalyst according to [1] or [2], wherein the aforementioned metal element is at least one metal element selected from a group consisting of zirconium, titanium, tantalum, and niobium.

[4] The electrode catalyst according to [1] or [2], wherein the aforementioned metal element is zirconium or titanium.

[5] The electrode catalyst according to [1] or [2], wherein the aforementioned metal element is zirconium.

[6] The electrode catalyst according to [5], wherein the aforementioned metal compound is zirconium oxide.

[7] An electrode catalyst composition having the electrode catalyst according any one of [1] to [6].

### EFFECTS OF THE INVENTION

According to the present invention, it is possible to provide an electrode catalyst which exhibits relatively high activity, and which is insoluble even at high potential in an acidic electrolyte. In addition, an electrode catalyst can be obtained using a material that is relatively inexpensive, and that is in relatively abundant resource supply, thereby rendering the present invention extremely useful in industrial terms.

### BRIEF DESCRIPTION OF THE DRAWINGS

FIG. 1 is a schematic view which shows an outline of a circulating reactor that serves to conduct a continuous hydrothermal reaction.

FIG. 2 is a schematic view which shows an outline of a reaction chamber in a circulating reactor.

FIG. 3 is a schematic view which shows an outline of a circulating reactor that serves to conduct a continuous hydrothermal reaction.

FIG. 4 is a schematic view which shows an outline of a reaction chamber in a circulating reactor.

FIG. 5 is a graph which shows the results of examples.

FIG. 6 is a table which shows the results of examples.

### MODE FOR CARRYING OUT THE INVENTION

A description is given below of an electrode catalyst pertaining to an embodiment of the present invention.

(Electrode Catalyst)

The electrode catalyst of the present embodiment is composed of a metal compound containing an oxygen atom and at least one metal element selected from a group consisting of Group 4 elements and Group 5 elements in the long-form periodic table, and a carbonaceous material covering at least part of the metal compound, and has an oxygen deficiency index of 0.125 to 0.170, and a crystallinity index of 4.5 to 8.0.

Now, the oxygen deficiency index of the present invention is a value represented by an inverse number of a peak value of a first nearest neighbor element in a radial distribution function obtained by Fourier-transforming an EXAFS oscillation in EXAFS measurement of the metal element contained in the aforementioned metal compound.

The crystallinity index of the present invention is a value represented by a peak value of a second nearest neighbor element in a radial distribution function obtained by Fourier-transforming an EXAFS oscillation in EXAFS measurement of the metal element contained in the aforementioned metal compound.

According to the aforementioned invention, an electrode catalyst can be obtained which uses a material that is relatively inexpensive and in relatively abundant resource supply, and which also exhibits relatively high activity in an acidic electrolyte at a relatively high potential such as 0.4 V or more. By means of the electrode catalyst of the present invention, it is possible to obtain a larger oxygen reduction current in an electrochemical system. A description is given in sequence below.

In the following description, “Group 4 elements” refer to “Group 4 elements in the long-form periodic table” unless otherwise specified, and “Group 5 elements” similarly refer to “Group 5 elements in the long-form periodic table” unless otherwise specified.

(Metal Compound)

First, a description is given of the metal compound composing the electrode catalyst of the present embodiment. The metal compound composing the electrode catalyst is a metal compound containing an oxygen atom and at least one metal element selected from a group consisting of Group 4 elements and Group 5 elements. With respect to the metal element(s) composing the metal compound, Zr, Ti, Ta, or Nb is preferable, and Zr or Ti is more preferable. As the metal compound composing the electrode catalyst of the present invention, zirconium oxide is preferable.

(Property of Metal Compound: Oxygen Deficiency Index)

The metal compound has a particulate form, and preferably lacks oxygen atoms in the particle surface, because an effect of promoting an oxidation reduction reaction during a catalytic reaction can be anticipated from the existence of such an oxygen-atom deficient portion. The degree of this absence of oxygen atoms can be represented by the aforementioned oxygen deficiency index.

The oxygen deficiency index is a value represented as an inverse number of a peak value of a first nearest neighbor element in a radial distribution function obtained by Fourier-transforming an EXAFS oscillation in EXAFS measurement using the K-absorption end of Zr in the case where, for example, zirconium oxide is used as the metal compound. Similarly, in the case where the metal element contained in the metal compound is Nb or Ti, the oxygen deficiency index is obtained based on an EXAFS oscillation in EXAFS measurement using the K-absorption end. In the case where the metal element contained in the metal compound is Ta, the oxygen deficiency index is obtained based on an EXAFS oscillation in EXAFS measurement using the L3-absorption end.

The obtained radial distribution function uses Zr as the central atom, and represents a probability density distribution of atoms existing at positions located at a prescribed distance from Zr. In the case where zirconium oxide is measured, the element that neighbors the Zr atom (the first nearest neighbor element) is oxygen. Specifically, when the peak value of the first nearest neighbor element is large, it indicates that oxygen is abundantly present at positions located at a distance from Zr corresponding to the Zr-O coupling length in zirconium oxide crystal.

In the present invention, by computing an inverse number of a peak value of the first nearest neighbor element of the radial distribution function obtained by the aforementioned measurement, the inverse number is used as an oxygen deficiency index indicating the degree of absence of oxygen.

A large oxygen deficiency index signifies that the peak value of the first nearest neighbor element is small, and indicates that oxygen atoms are absent from the positions where they by nature ought to be. That is, when the oxygen deficiency index is large, the degree of oxygen absence in the measurement region is large, and when the oxygen deficiency index is small, the degree of oxygen absence in the measurement region is small.

As a required physical property of the target electrode catalyst, the oxygen deficiency index of the metal compound is preferably 0.125 to 0.170, and more preferably 0.125 to 0.140.

(Property of Metal Compound: Crystallinity Index)

In order to achieve high catalytic activity, it is preferable that the metal compound have a more orderly crystal structure. When such an orderly crystal structure exists, the effect can be anticipated that electron exchange with the metal compound will not be impeded at the time of the oxidation reduction reaction in the catalytic reaction, with the result that the catalytic reaction will not be impeded. The degree of such a crystal condition can be represented by the aforementioned crystallinity index.

In the following description, the existence of an orderly crystal structure in the metal compound is expressed by the phrase “crystallinity of the metal compound is high,” and the existence of a collapsed crystal structure is expressed by the phrase “crystallinity of the metal compound is low,” for the crystal condition is indicated by whether “crystallinity” is high or low in some cases.

In the case where, for example, zirconium oxide is used as the metal compound, the crystallinity index is a value represented as a peak value of a second nearest neighbor element in a radial distribution function obtained by Fourier-transforming an EXAFS oscillation in EXAFS measurement using the K-absorption end of Zr. Similarly, in the case where the metal element contained in the metal compound is Nb or Ti, the crystallinity index is obtained based on an EXAFS oscillation in EXAFS measurement using the K-absorption end, and in the case where the metal element is Ta, the crystallinity index is obtained based on an EXAFS oscillation in EXAFS measurement using the L3-absorption end.

In the case where zirconium oxide is measured, Zr is the element which is positioned next to the oxygen that is the first nearest neighbor element from the perspective of the Zr atom. That is, when the peak value of the second nearest neighbor element is large, it indicates that there is an abundant presence of Zr located at a distance from Zr corresponding to the Zr—O—Zr coupling length in the zirconium oxide crystal. Conversely, a small peak value of the second nearest neighbor element means that Zr atoms are absent from the prescribed positions where they ought to be.

The cause of this phenomenon that “Zr atoms are absent from the prescribed positions” is understood to stem from a collapsed crystal structure, and in the present invention, the peak value of the second nearest neighbor element of the radial distribution function obtained by the above-described measurement is used as a crystallinity index indicating the condition of the crystal structure of the metal compound. That is, when the crystallinity index is large, the collapse of the crystal structure in the measurement region is small (crystallinity is high), and when the crystallinity index is small, the collapse of the crystal structure in the measurement region is large (crystallinity is low).

As a required physical property of the target electrode catalyst, the crystallinity index of the metal compound is preferably high, and is preferably 4.5 to 8.0, more preferably 5.0 to 7.5, and still more preferably 5.8 to 6.8.

(Carbonaceous Material)

Next, a description is given of the carbonaceous material composing the electrode catalyst of the present embodiment. In the present embodiment, “carbonaceous material” includes a material which has carbon as its primary ingredient, and which is obtained by calcining a mixture of the metal compound and organic matter to carbonize the organic matter. The meaning of “having carbon as its primary ingredient” is that the carbonaceous material is a material in which, for example, 95 mol % or more of the entirety is carbon atoms.

In the electrode catalyst of the present embodiment, the carbonaceous material covers at least a portion of the surface of the aforementioned particulate metal compound. The carbon content of the electrode catalyst is preferably 0.1 mass % to 50 mass %, more preferably 0.5 mass % to 45 mass %, still more preferably 3 mass % to 40 mass %, and even more preferably 15 mass % to 35 mass %.

In the present embodiment, the weight loss rate (ignition loss value) computed by the following formula is adopted as the carbon content. Specifically, when the electrode catalyst of the present embodiment is placed in an alumina crucible, and is calcined for 3 hours at 1000° C. in ambient atmosphere, the value of carbon content computed by the following formula is used.

[Formula 2]

Carbon content (mass %)=weight loss rate (mass %)=(W_{I}−W_{A})/W_{I}×100 (2)

(Here, W_{I} is electrode catalyst mass before calcination, and W_{A} is mass after calcination.)

(Property of Electrode Catalyst: Surface Area)

It is preferable that the electrode catalyst of the present embodiment have a large surface area in order to enhance catalytic activity. As the surface area of the electrode catalyst, the specific surface area obtained by the common BET method can be adopted. In the electrode catalyst of the present embodiment, the BET specific surface area is preferably 15 m²/g to 500 m²/g, and more preferably 50 m²/g to 300 m²/g. By setting the BET specific surface area in this manner, catalytic activity can be further enhanced.

(Property of Electrode Catalyst: Carbon Coverage)

In the electrode catalyst in the present embodiment, a carbonaceous material covers at least a portion of the metal compound that composes the electrode catalyst in the aforementioned manner.

The electrode catalyst of the present invention functions in the aggregate as an electrode catalyst by forming a carbonaceous material covering the surface of the metal compound to obtain electron flow required to the catalytic reaction that is produced at the surface (interface) of the metal compound.

Consequently, although the electrode catalyst will function even if the coverage rate of the carbonaceous material falls outside of the fixed range, it is preferable that the coverage rate of the carbonaceous material be within the fixed range. This is because, when the coverage rate falls below the values of the fixed range, conductivity as an electrode catalyst decreases due to the small amount of the carbonaceous material covering the metal compound, rendering satisfactory catalytic activity unobtainable, and when the coverage rate exceeds the values of the fixed range, satisfactory catalytic activity cannot be obtained after all, as the exposed area of the surface of the metal compound that is capable of functioning as reaction points of the catalytic reaction is reduced.

Carbon coverage (g/m²) can be obtained by the following formula (3). With the electrode catalyst of the present embodiment, carbon coverage is preferably 0.05 to 0.5, and more preferably 0.1 to 0.3. By setting carbon coverage in this manner, the catalytic activity of the electrode catalyst can be further increased.

[Formula 3]

Carbon coverage (g/m²)=carbon content (mass %)/BET specific surface area (m²/g) (3)

(Formative Materials of Electrode Catalyst)

Next, a description is given of the method of manufacture of the electrode catalyst of the present embodiment. The electrode catalyst of the present embodiment can be manufactured with a below-mentioned first material and second material as the formative materials.

First, the first material used to manufacture the electrode catalyst of the present embodiment is a precursor of the aforementioned metal compound. Specifically, the first material is a compound composed of at least one metal element selected from a group consisting of Group 4 elements and Group 5 elements, and at least one non-metal element selected from among hydrogen atoms, nitrogen atoms, chlorine atoms, carbon atoms, boron atoms, sulfur atoms, and oxygen atoms.

The metal element composing the first material contains a metal element of Group 4 elements or Group 5 elements. From the standpoint of stability in an acidic solution, the metal element is preferably Zr, Ti, Ta, or Nb; more preferably Zr or Ti; and still more preferably Zr.

In addition, the preferred non-metal element composing the first material is at least one non-metal element selected from among hydrogen atoms, chlorine atoms, and oxygen atoms.

As the first material in the case where the metal element is Zr, one may cite, for example, zirconium hydroxide and zirconium oxychloride. As the first material in the case where the metal element is Ti, one may cite, for example, titanium hydroxide, titanium tetrachloride, metatitanic acid, orthotitanic acid, titanium sulfate, and titanium alkoxide. This type of first material can be used in a slurried state in which water is the dispersion medium.

Next, the second material used to manufacture the electrode catalyst of the present embodiment is a precursor of the aforementioned carbonaceous material (carbonaceous material precursor). In the present invention, the carbonaceous material precursor is induced to change into a carbonaceous material by high-temperature heat treatment (calcination).

As the carbonaceous material precursor, one may cite, for example, saccharides such as glucose, fructose, sucrose, cellulose, and hydropropyl cellulose; alcohols such as polyvinyl alcohol; glycols such as polyethylene glycol and polypropylene glycol; polyesters such as polyethylene terephthalate; nitriles such as acrylonitrile and polyacrylonitrile; various proteins such as collagen, keratin, ferritin, hormone, hemoglobin, and albumin; biomatter including amino acids such as glycine, alanine, and methionine; as well as ascorbic acid, citric acid, stearic acid.

With respect to the second material, the materials having oxygen among the aforementioned materials are preferable.

(Method for Manufacturing Electrode Catalyst)

The electrode catalyst of the present embodiment can be manufactured by the following manufacturing method using the aforementioned first material and second material.

Specifically, a mixture containing the aforementioned first material and the aforementioned second material is preheated, and the preheated mixture is subjected to a continuous hydrothermal reaction in the presence of water that is in a supercritical or subcritical state to obtain a mixed precursor that is a reaction product resulting from the hydrothermal reaction of the mixture, and the electrode catalyst is then manufactured by calcining the obtained mixed precursor.

(Hydrothermal Reaction)

First, a description is given of the hydrothermal reaction used in the method for manufacturing an electrode catalyst.

The critical point of water is 374° C. (critical temperature) and 22 MPa (critical pressure):

In the present invention, water that is in a supercritical state signifies water that has a temperature of at least 374° C. and that has a pressure of at least 22 MPa.

In the present invention, water that is in a subcritical state is water that maintains a liquid state under high-temperature and high-pressure conditions even though temperature and pressure are below the critical point. Specifically, such water in a subcritical state is preferably water which has a temperature of at least 250° C. and a pressure of at least 20 MPa, but which has a temperature and a pressure that are less than the critical point of water.

(Reactor)

In the present embodiment, a continuous (circulating) reactor may be used as the reactor that serves to conduct the hydrothermal reaction.

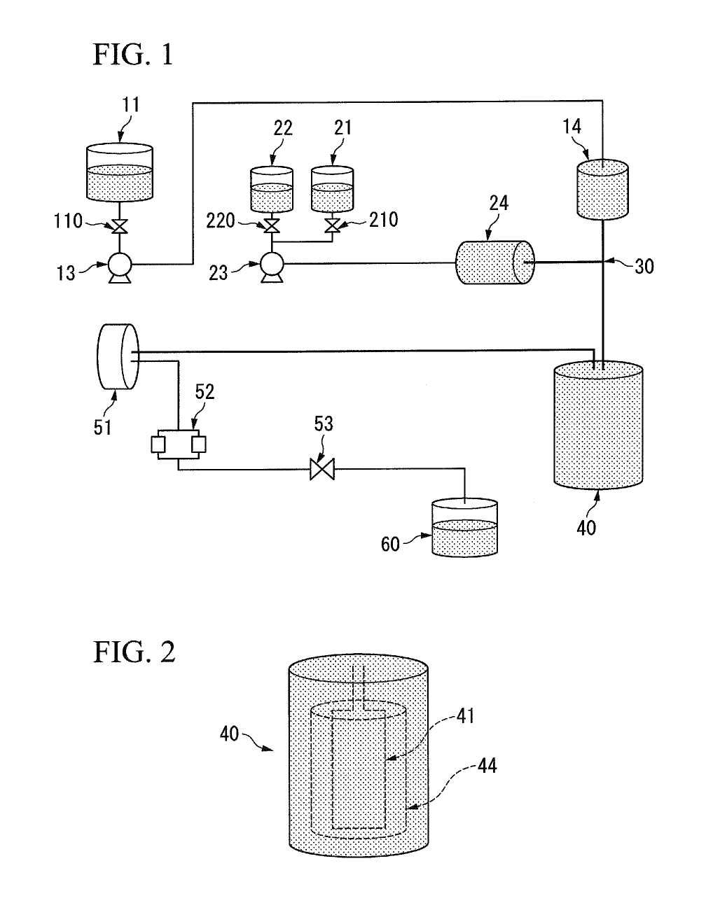

A description is given below of the reactor for a continuous hydrothermal reaction that is used in the present embodiment, with reference to FIG. 1 and FIG. 2. In all of the following drawings, the dimensions and proportions of the various components have been appropriately varied in order to facilitate viewing of the drawings.

FIG. 1 is a drawing which shows an outline of a circulating reactor that serves to continuously carry out a hydrothermal reaction.

As shown in the drawing, the circulating reactor recovers the reactant in a recovery vessel 60 by reacting a raw material, which is supplied from a raw material tank 22, by means of the hydrothermal reaction that is produced principally in a reaction chamber 40, while circulating the raw material under a high-temperature and high-pressure environment inside the apparatus.

Water tanks 11 and 21 are tanks that serve to supply water. The raw material tank 22 is a tank that serves to supply a raw material slurry. The raw material slurry is a slurry or solution of a mixture containing the first material and the second material.

From these water tanks 11 and 21 and raw material tank 22, a stored liquid is supplied to the interior of the apparatus by respectively opening valves 110, 210, and 220. A liquid-feeding pump 13 provided on the downstream side of the valve 110 feeds water from the water tank 11 to a heating chamber 14.

On the other hand, pipes extending from the water tank 21 and the raw material tank 22 converge on the downstream side of the valves 210 and 220. A liquid-feeding pump 23 is provided on the downstream side of the convergence, and feeds either or both of water supplied from the water tank 21 and the raw material slurry supplied from the raw material tank 22 to a heating chamber 24.

In the heating chamber 24, the raw material slurry is preheated. The temperature range of the preheating is preferably 100° C. to 330° C., and more preferably 150° C. to 300° C. The hydrothermal reaction of the mixture may be partially conducted by preheating this mixture. The respectively transported liquids are mixed in a mixing unit 30, producing a reaction by the hydrothermal reaction principally in the reaction chamber 40.

FIG. 2 is a drawing which shows an outline of the reaction chamber 40. Inside the reaction chamber 40, there is an internal pipe 41, and a heating chamber 44 that heats the pipe, and the internal pipe 41 is connected to an external pipe.

Reaction time can be regulated by adjusting the length of the internal pipe 41 inside the reaction chamber 40. For purposes of adjusting the length of the internal pipe 41, various shapes such as a zigzag shape, a helical shape, and the like may be selectively employed as the shape of the internal pipe 41.

The material of the pipes and the internal pipe may be suitably selected based on conditions such as the type of raw material slurry, and the temperature and pressure of the hydrothermal reaction. One may cite, for example, stainless steel such as SUS 316, nickel alloys such as Hastelloy and Inconel, or titanium alloy.

According to the properties of the transiting liquid, part or all of the inner surface of the pipe may be lined with a highly corrosion resistant material such as gold.

Returning to FIG. 1, the slurry (generated slurry) containing the reaction product after the hydrothermal reaction is cooled in a cooling chamber 51 provided on the downstream side of the reaction chamber 40, passes through a filter 52 and a back-pressure valve 53, and is recovered in the recovery vessel 60.

In such an apparatus, the water that flows through the interior of the apparatus can be put into a supercritical state or a subcritical state by opening valve 110 and valve 210 or valve 220, operating the liquid-feed pumps 13 and 23, and additionally by regulating the pressure inside the pipes from the liquid-feed pumps 13 and 23 to the back-pressure valve 53 by opening/closing of the back-pressure valve 53, and by regulating the temperature of the heating chambers 14 and 24 and the heating chamber 44 in the reaction chamber 40.

More specifically, the liquid-feed pumps 13 and 23 are activated, pressure inside the pipes is suitably adjusted using the back-pressure valve 53, temperatures inside the heating chambers 14 and 24 and the reaction chamber 40 are suitably adjusted, and temperature inside the reaction chamber is raised so that the water may enter a supercritical state or subcritical state. When the raw material slurry is dispatched from the raw material tank 22, the hydrothermal reaction occurs inside the pipe from the mixing unit 30 onward, and the generated slurry can be recovered in the recovery vessel 60. There is obtained as the generated slurry a mixed precursor produced from the hydrothermal reaction of the mixture of the first material and the second material.

At about the time when the raw material slurry is dispatched from the raw material tank 22, it is also possible to dispatch water from the water tank 21, and to perform preheating of the pipes, cleaning of the pipes, and the like. Moreover, the particle size of the generated slurry after the hydrothermal reaction may also be adjusted by conducting removal of coarse particles using the filter 52.

The generated slurry recovered in the recovery vessel 60 may be used in a particulate state or a slurried state by conducting solid-liquid separation, washing, and drying in later manufacturing steps such as mixing and calcination.

(Calcination)

Next, a description is given of the calcination step used in the method for manufacturing an electrode catalyst.

In the present embodiment, the target electrode catalyst is obtained by calcining the aforementioned mixed precursor under conditions where the second material is capable of changing into a carbonaceous material. With respect to the atmosphere during calcination, it is preferable to conduct calcination in a non-oxygen atmosphere for purposes of efficiently synthesizing the electrode catalyst, and it is preferable from a cost standpoint that the non-oxygen atmosphere be a nitrogen atmosphere.

With respect to the furnace used during calcination, it is sufficient if it is a furnace capable of atmospheric control, and one may cite, for example, a tubular electric furnace, tunnel furnace, far-infrared furnace, microwave heating furnace, roller hearth furnace, and rotary furnace, although one is not limited thereto. The atmospheric control may be conducted batch-wise, or it may be conducted continuously. Moreover, stationary calcination may be conducted in which the mixed precursor is calcined in a stationary state, or circulating calcination may be conducted in which the mixed precursor is calcined in a circulating state.

Calcination temperature is appropriately set according to the type of calcination atmosphere and second material (carbonaceous material precursor), and may be set at a temperature where the second material is capable of changing into a carbonaceous material, i.e., a temperature where the second material decomposes and carbonizes. Specifically, the calcination temperature is, for example, 400° C. to 1100° C., preferably 500° C. to 1000° C., more preferably 500° C. to 900° C., and still more preferably 700° C. to 900° C. The BET specific surface area of the electrode catalyst can be controlled by controlling calcination temperature. In the present invention, conditions where the second material is capable of changing into a carbonaceous material signify conditions where the second material is capable of becoming a carbonaceous material by decomposition and carbonization.

There are no limitations on the rate of temperature increase during calcination, provided that it is within a practical range. It is ordinarily 10° C./hour to 600° C./hour, and preferably 50° C./hour to 500° C./hour. Calcination may be carried out by raising the temperature to the aforementioned calcination temperature at this rate of temperature increase, and by maintaining it for 0.1-24 hours, and preferably 1-12 hours.

The electrode catalyst of the present embodiment can be manufactured using the method described above.

By means of the electrode catalyst of the present invention, it is possible to obtain a larger oxygen reduction current in an electrochemical system. The value of the oxygen reduction current per unit area of electrode in the electrode catalyst of the present invention is preferably at least 1000 μA/cm², and more preferably at least 1500 μA/cm².

(Electrode Catalyst Composition)

Using the aforementioned electrode catalyst, it is also possible to make an electrode catalyst composition containing the electrode catalyst. An electrode catalyst composition ordinarily has a dispersion medium. The electrode catalyst composition can be obtained by dispersing the electrode catalyst in the dispersion medium. As a dispersion medium, one may cite alcohols such as methanol, ethanol, isopropanol, and normal propanol; water such as ion exchange water; and the like.

In the electrode catalyst composition of the present invention, the mass of the dispersion medium is ordinarily 1 mass part to 100 mass parts, and preferably 2 mass parts to 50 mass parts, relative to 100 mass parts of the electrode catalyst.

During dispersion, a dispersion agent may be used. As the dispersion agent, one may cite, for example, inorganic acids such as nitric acid, hydrochloric acid, and sulfuric acid; organic acids such as oxalic acid, citric acid, acetic acid, maleic acid, and lactic acid; aqueous zirconium salts such as zirconium oxychloride; surface active agents such as ammonium polycarbonate and sodium polycarbonate; and catechins such as epicatechin, epigallocatechin, and epigallocatechin gallate.

The electrode catalyst composition of the present invention may also contain an ion exchange resin, and is particularly well-suited for use in fuel cells when it contains the ion exchange resin. As the ion exchange resin, one may cite a fluorine-based ion exchange resin such as Nafion (a registered trademark of DuPont Corporation), a hydrocarbon-based ion exchange resin such as sulfonated phenol formaldehyde resin, and so on.

The electrode catalyst composition of the present invention may also contain a conductive material. As the conductive material, one may cite carbon fiber, carbon nanotube, carbon nanofiber, conductive oxide, conductive oxide fiber, conductive resin, or the like. In addition, the electrode catalyst composition may also contain noble metals such as Pt and Ru, and transition metals such as Ni, Fe, and Co. In the case where such noble metals and transition metals are included, their proportional content is preferably extremely low (e.g., on the order of 0.1 mass part to 10 mass parts relative to 100 mass parts of electrode catalyst).

The electrode catalyst of the present embodiment may be used in an electrochemical system, and may be preferably used as the electrode catalyst of a fuel cell, more preferably as the electrode catalyst of a solid polymer fuel cell, and still more preferably as the electrode catalyst of the cathode portion of a solid polymer fuel cell.

As the electrode catalyst of the present embodiment has relatively high activity, and may be suitably used at a potential of 0.4 V or more in terms of reversible hydrogen electrode potential in an acidic electrolyte, it is effective as an oxygen reduction catalyst that is supported on an electrode and that is used for reducing oxygen in, for example, an electrochemical system.

When used as an oxygen reduction catalyst, a suitable upper limit of potential will depend on the stability of the electrode catalyst, but use is possible up to 1.6 V which is the potential of oxygen generation. When 1.6 V is exceeded, the electrode catalyst is gradually oxidized from the surface simultaneously with oxygen generation, and the electrode catalyst is completely oxidized, and deactivated. When potential is less than 0.4 V, although this is favorable from the standpoint of the stability of the electrode catalyst, it results in poor effectiveness from the standpoint of an oxygen reduction catalyst in some cases.

The electrode catalyst composition may also be supported on an electrode such as carbon cloth or carbon paper for use in electrolysis of water or electrolysis of organic matter in an acidic electrolyte.

In addition, it may also be used by being supported on an electrode composing a fuel cell such as a solid polymer fuel cell, and phosphoric acid fuel cell.

While a preferred embodiment of the invention has been described and illustrated above with reference to appended drawings, it should be understood that this is exemplary of the invention, and is not to be considered as limiting. The combinations of equipment configurations and materials illustrated in the foregoing examples are exemplary, and may be modified in various ways based on design requirements and the like without departing from the spirit or scope of the present invention.

### EXAMPLES

The present invention is described in further detail below by means of examples, but the present invention is not limited by these examples.

The evaluation method of the respective examples is as follows.

(1) The BET specific surface area (m²/g) is obtained by the nitrogen adsorption method (in conformity with MS-Z8830 “Method of specific surface area measurement of powders (solids) by gas adsorption”)

(2) Crystal structure is found using a powder x-ray diffractometer (X'Pert Pro MPD, manufactured by PANalytical Co.)

(3) With respect to carbon content, the obtained electrode catalyst is placed in an alumina crucible, and calcined for 3 hours at 1000° C. in ambient atmosphere in a box-type furnace, and the weight loss rate (ignition loss value) computed by the following formula (4) is adopted.

[Formula 4]

Carbon content (mass %)=(W_{I}−W_{A})/W_{I}×100 (4)

(Here, W_{I} is electrode catalyst mass before calcination, and W_{A} is mass after calcination.)

(4) Carbon coverage is computed by the following formula (5).

[Formula 5]

Carbon coverage (g/m²)=carbon content (mass %)/BET specific surface area (m²/g) (5)

(5) The oxygen deficiency index is obtained by adopting an inverse number of a peak value of the first nearest neighbor element (oxygen) observed at 1.6 A to 1.7 A in an EXAFS (Extended X-Ray Absorption Fine Structure) result of transmission XAFS (X-Ray Absorption Fine Structure) measurement using the Zr-K absorption end.

(6) The crystallinity index is obtained by adopting a peak value of the second nearest neighbor element (zirconium) observed at 3.0 Å to 4.0 Å in an EXAFS result of transmission XAFS measurement using the Zr-K absorption end.

(Manufacturing Example 1: Preparation of Slurry of First Material (Zr-containing Compound))

Using an aqueous NH₃ solution (manufactured by Kanto Chemical Co. Ltd.; diluted to 4 mass %), and an aqueous solution obtained by dissolving zirconium oxychloride (manufactured by Wako Pure Chemical Industries Co., Ltd.) in pure water (8 mass % of zirconium oxychloride), neutralization was conducted, and the obtained precipitate was recovered by filtration and washing. As a result of powder x-ray diffraction measurement, this precipitate was ascertained to be zirconium hydroxide.

The obtained zirconium hydroxide was dispersed to a concentration of 1 mass % in an NH₃ aqueous solution adjusted to a pH of 10.5, and a slurry of zirconium hydroxide was obtained.

(Manufacturing Example 2: Preparation of First Material (Zr-containing Compound) Slurry)

Commercially available zirconium hydroxide (brand name: R-zirconium hydroxide, manufactured by Daiichi Kigenso Co.) was dispersed to a concentration of 1 mass % in an NH₃ aqueous solution adjusted to a pH of 10.5, and a slurry of zirconium hydroxide was obtained.

### Example 1

(Preparation of Electrode Catalyst)

6 g of glucose (manufactured by Wako Pure Chemical Industries Co.) were added to 600 mL of zirconium hydroxide slurry obtained according to manufacturing example 1, and the raw material tank 22 of a circulating reactor (manufactured by Itec, Inc.) was charged with this mixture. The water tanks 11 and 21 were charged with water, the liquid-feed pumps 13 and 23 were activated, the valves 110 and 210 were opened, and supply of the respective water was started.

Here, adjustments were respectively conducted so that the flow rate in the liquid-feed pump 13 was 16.7 mL/minute, and the flow rate in the liquid-feed pump 23 was 6.66 mL/minute. Using the back-pressure valve 53, pressure inside the pipes was adjusted to 30 MPa. Adjustments were respectively conducted so that the temperature was 400° C. in the heating chamber 14, 250° C. in the heating chamber 24, and 350° C. in the heating chamber 44 inside the reaction chamber 40. Steady-state liquid temperature in the mixing unit 30 was 380° C. upon measurement, confirming that the water was in a supercritical state.

Subsequently, by closing the valve 210, and opening the valve 220, changeover occurred from the water tank 21 to the raw material tank 22, a raw material slurry was supplied from the raw material tank 22, a hydrothermal reaction occurred, and a generated slurry was recovered in the recovery vessel 60. The generated slurry that was recovered was subjected to solid-liquid separation by filtration, and was dried for 3 hours at 60° C. to obtain the mixed precursor.

The obtained mixed precursor was placed in an alumina boat, and calcined in a tubular electric furnace (manufactured by Motoyama, Ltd.) with circulation of nitrogen gas at a flow rate of 1.5 L/minute by raising the temperature from room temperature (approximately 25° C.) to 800° C. at a rate of temperature increase of 300° C./hour, and maintaining it at 800° C. for one hour, thereby obtaining an electrode catalyst 1.

The obtained electrode catalyst 1 was ascertained to be zirconium oxide covered with carbon by conducting carbon mapping using EF-TEM. The BET specific surface area of the electrode catalyst was 116 m²/g, carbon content was 12.3 mass %, carbon coverage was 0.11 g/m², and the crystal form was a tetragonal and orthorhombic multiphase.

### Example 2

(Preparation of Electrode Catalyst)

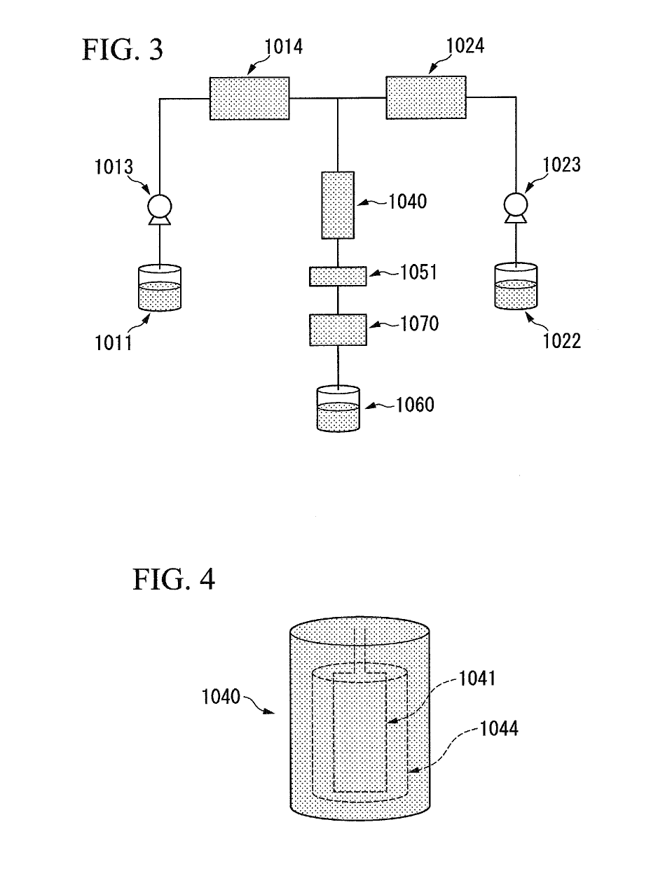

As the circulating reactor, the commercially available supercritical water nanoparticle synthesis tester (manufactured by Itec, Inc.; MOMI Supermini) shown in FIGS. 3 and 4 was used. FIGS. 3 and 4 are drawings corresponding to the above-described FIGS. 1 and 2.

A raw material tank 1022 was charged with a mixture obtained by adding 2.6 g of glucose as the second material to 175 g of slurry of the zirconium hydroxide obtained in manufacturing example 2, and this mixture was injected into the flow path. At this time, adjustments were respectively conducted so that the flow rate of a pump 1013 corresponding to the liquid-feed pump 13 of FIG. 2 was 8 mL/minute, and the flow rate of a pump 1023 corresponding to the liquid-feed pump 23 of FIG. 2 was 3.4 mL/minute.

In addition, reaction pressure was set to 20 MPa, and subcritical conditions were established inside the flow path of the apparatus.

The temperature of a raw material line heater 1024 corresponding to the heating chamber 24 of FIG. 2 was set to 180° C., the temperature of a pure water line heater 1014 corresponding to the heating chamber 14 of FIG. 2 was set to 400° C., and the temperature of a reaction line heater 1040 corresponding to the reaction chamber 40 of FIG. 2 was set to 350° C. As shown in FIG. 4, the reaction line heater 1040 has an internal pipe 1041 and a heating chamber 1044; by setting the temperature of the heating chamber 1044 to 350° C., heating is conducted at the temperature set for the entirety of the reaction line heater 1040. In addition, the liquid temperature at the outlet of the raw material line heater 1024 was 180° C.

The resultant generated slurry transited a recovery unit 1070 having the same functions as the cooling chamber 51 and the filter 52 of FIG. 2, after which it was collected in a recovery vessel 1060 corresponding to the recovery vessel 60 of FIG. 2.

The resultant generated slurry was treated for 10 minutes at 3000 rpm using a centrifugal separator (manufactured by Kubota Corporation; Model No. 9912), the supernatant was removed, and the precipitate was dried at 60° C. to obtain a mixed precursor of an electrode catalyst.

The resultant mixed precursor was placed in an alumina boat, and calcined in a tubular electric furnace (manufactured by Motoyama, Ltd.) with circulation of nitrogen gas at a flow rate of 1.5 L/minute by raising the temperature from room temperature (approximately 25° C.) to 800° C. at a rate of temperature increase of 300° C./hour, and maintaining it at 800° C. for one hour, thereby obtaining an electrode catalyst 2.

The resultant electrode catalyst 2 was ascertained to be zirconium oxide covered with carbon by the same method employed in example 1. The BET specific surface area of the electrode catalyst was 153 m²/g, carbon content was 12.8 mass %, carbon coverage was 0.08 g/m², and the crystal form was a tetragonal and orthorhombic multiphase.

### Comparative Example 1

(Preparation of Electrode Catalyst)

Using a Zr-containing compound slurry obtained according to manufacturing example 2 as the first material, the temperature settings of the respective heaters in the circulating reactor used in example 1 were identical to those of example 1, except that the heater of the heating chamber 24 was turned off, and the resultant “mixed precursor” was subjected to heat treatment in the same manner as example 1 to obtain an electrode catalyst 3.

Otherwise, the steady-state liquid temperature of the mixing unit 30 was 367° C. upon measurement in the same manner as example 1, confirming that the water was in a subcritical state.

The obtained electrode catalyst 3 was ascertained to be zirconium oxide covered with carbon by the same method employed in example 1. The BET specific surface area of the electrode catalyst was 69 m²/g, carbon content was 4.5 mass %, carbon coverage was 0.06 g/m², and the crystal form was a tetragonal and orthorhombic multiphase.

(Evaluation of Oxygen Deficiency Index and Crystallinity Index)

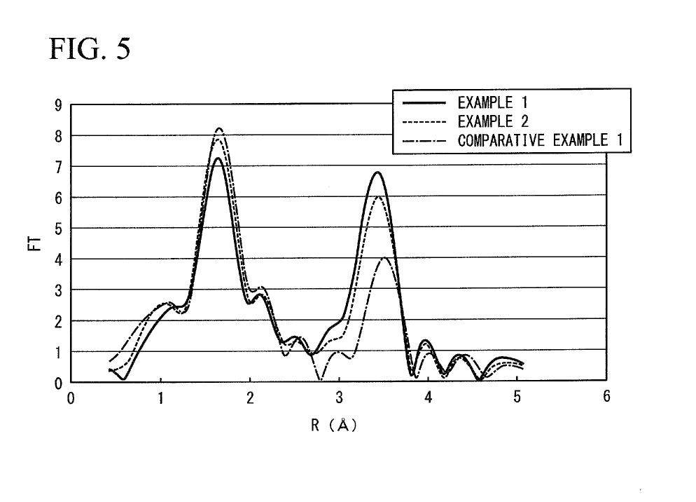

Transmission XAFS measurement was conducted with respect to each of the electrode catalysts 1-3 obtained in the aforementioned examples 1 and 2 and comparative example 1, and the oxygen deficiency index and crystallinity index were obtained from the EXFAS results. FIG. 5 is a graph which shows the radial distribution functions obtained for the respective electrode catalysts. With respect to the evaluation results, for electrode catalyst 1, the oxygen deficiency index was 0.138, and the crystallinity index was 6.8. For electrode catalyst 2, the oxygen deficiency index was 0.128, and the crystallinity index was 6.0.

In contrast, for electrode catalyst 3, the oxygen deficiency index was 0.122, and the crystallinity index was 4.0.

(Evaluation in Electrochemical System) With respect to each of the electrodes 1-3 obtained in the aforementioned examples 1 and 2 and comparative example 1, electrochemical properties were evaluated according to the following method.

0.02 g of the electrode catalyst was weighed out, and added to a mixed solvent of 5 mL of pure water and 5 mL of isopropyl alcohol. The mixture was ultrasonically irradiated to obtain a suspension, and 20 μL of the suspension was applied to a glassy carbon electrode (6 mm in diameter, with an electrode area of 28.3 mm²), and dried. Next, 13 μL of “Nafion®” (manufactured by DuPont Corp.; 10-fold diluted sample with a solid content concentration of 5 mass %) was applied thereon, and dried, after which vacuum drying treatment was conducted for one hour in a vacuum drier to obtain a modified electrode having an electrode catalyst supported on the glassy carbon electrode.

This modified electrode was immersed in an aqueous sulfuric acid solution with a concentration of 0.1 mol/L. Potential was cycled at a scanning rate of 50 mV/s in a scanning range of −0.25 V to 0.75 V (0.025 V to 1.025 V in terms of reversible hydrogen electrode potential conversion) relative to silver-silver chloride electrode potential, and this was done at room temperature, under atmospheric pressure, and in an oxygen atmosphere, and a nitrogen atmosphere. The current values at the respective potentials were compared by cycle to check electrode stability.

In addition, a comparison was conducted of the current values in an oxygen atmosphere and a nitrogen atmosphere at a potential of 0.4 V relative to reversible hydrogen electrode potential to obtain the oxygen reduction current.

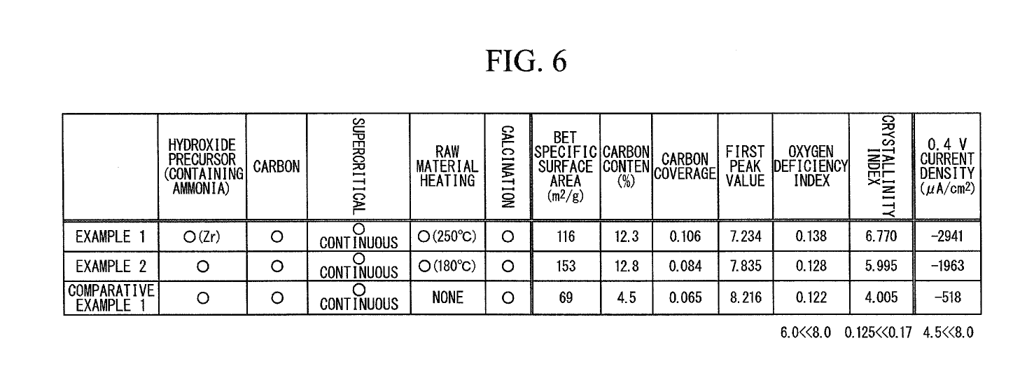

Summarizing the foregoing results, FIG. 6 shows the respective measurement values for the electrode catalyst of examples 1 and 2 and comparative example 1.

First, with respect to the evaluation results, all of the electrode catalysts 1-3 exhibited stability, without variation of current values in the scanning potential range.

As shown in FIG. 6, the oxygen reduction current of the electrode catalyst 1 was 2941 μA/cm² per unit area of electrode, and the oxygen reduction current of the electrode catalyst 2 was 1963 μA/cm² per unit area of electrode.

In contrast, the oxygen reduction current of the electrode catalyst 3 was 518 μA/cm² per unit area of electrode, exhibiting a lower value than the oxygen reduction currents of electrode catalysts 1 and 2.

From the foregoing results, it can be ascertained that a correlation is observable between catalytic activity and the values of the oxygen deficiency index in the crystallinity index of the electrode catalyst, confirming the usefulness of the present invention.

### INDUSTRIAL APPLICABILITY

The electrode catalyst of the present invention exhibits relatively high activity in an acidic electrolyte without dissolving even at high potential, and is also useful as an electrode catalyst that is substitutable with electrode catalysts whose formative material is platinum.

### DESCRIPTION OF THE REFERENCE NUMERALS

11, 21: water tanks
22: raw material tank
13, 23: liquid-feed pumps
14, 24: heating chambers
30: mixing unit
40: reaction chamber
41: internal pipe
44: heating chamber
51: cooling chamber
52: filter
53: back-pressure valve
60: recovery vessel
110, 210, 220: valves
1013: pump
1014: pure water line heater
1022: raw material tank
1023: pump
1024: raw material line heater
1040: reaction line heater
1060: recovery vessel
1070: recovery unit

1. An electrode catalyst comprising: a metal compound which contains an oxygen atom and at least one metal element selected from a group consisting of Group 4 elements and Group 5 elements in the long-form periodic table, and a carbonaceous material which covers at least part of the metal compound,
wherein an oxygen deficiency index, which is represented as an inverse number of a peak value of a first nearest neighbor element in a radial distribution function obtained by Fourier-transforming an EXAFS oscillation in EXAFS measurement of said metal element, is 0.125 to 0.170,
and a crystallinity index, which is represented as a peak value of a second nearest neighbor element in said radial distribution function, is 4.5 to 8.0.

2. The electrode catalyst according to claim 1, wherein a BET specific surface area is 15 m²/g to 500 m²/g, and a carbon coverage obtained by the following formula (1) is 0.05 g/m² to 0.5 g/m², wherein Formula (1) is as follows:
Carbon coverage (g/m²)=carbon content (mass %)/BET specific surface area (m²/g).

3. The electrode catalyst according to claim 1, wherein said metal element is at least one metal element selected from a group consisting of zirconium, titanium, tantalum, and niobium.

4. The electrode catalyst according to claim 1, wherein said metal element is zirconium or titanium.

5. The electrode catalyst according to claim 1, wherein said metal element is zirconium.

6. The electrode catalyst according to claim 5, wherein said metal compound is zirconium oxide.

7. An electrode catalyst composition, having the electrode catalyst according to claim 1.
